(19) United States
(12) Patent Application Publication
(10) Pub. No.: US 2022/0124387 A1
(43) Pub. Date: Apr. 21, 2022

(54) METHOD FOR TRAINING BIT RATE DECISION MODEL, AND ELECTRONIC DEVICE

(71) Applicant: BEIJING DAJIA INTERNET INFORMATION TECHNOLOGY CO., LTD., Beijing (CN)

(72) Inventor: Chao ZHOU, Beijing (CN)

(21) Appl. No.: 17/562,687

(22) Filed: Dec. 27, 2021

Related U.S. Application Data
(63) Continuation of application No. PCT/CN2020/129671, filed on Nov. 18, 2020.

(30) Foreign Application Priority Data
Jan. 16, 2020 (CN) 202010046898.1

(51) Int. Cl. H04N 21/234; H04N 21/25; H04N 19/115; H04N 19/184; H04N 19/152

(52) U.S. Cl. CPC H04N 21/23406; H04N 21/251; H04N 19/152; H04N 19/184; H04N 19/115

(57) ABSTRACT

A method for training a bit rate decision model is provided. The method includes: acquiring first probabilities corresponding to first decision bit rates by inputting a network throughput at a first moment, first time length variation information, and a target decision bit rate at a second moment to a first model; determining a target decision bit rate at the first moment; acquiring second time length variation information by inputting the target decision bit rate at the first moment to the simulated interactive environment; acquiring a first evaluation value based on a network throughput at the third moment, the second time length variation information, and the target decision bit rate at the first moment; and updating a model parameter of the first model based on the first evaluation value until any iteration process meets a first iteration ending condition, to obtain a bit rate decision model.

### CROSS-REFERENCE TO RELATED APPLICATION

This application is a continuation application of international application No. PCT/CN2020/129671, filed on Nov. 18, 2020, which claims priority of Chinese Patent Application No. 202010046898.1, filed on Jan. 16, 2020, each of which is incorporated in its entirety by reference herein.

### TECHNICAL FIELD

The present disclosure relates to the field of video live streaming, and in particular, to a method for training a bit rate decision model, and an electronic device.

### BACKGROUND

Network fluctuations have a huge impact on live video streaming. In order to avoid lagging while maintaining a certain level of clarity, an electronic device needs to adjust a video stream bit rate according to the network fluctuations.

### SUMMARY

In an aspect, a method for training a bit rate decision model is provided. The method is performed by an electronic device and includes:

acquiring a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment;

determining a target decision bit rate at the first moment, the target decision bit rate at the first moment being a first decision bit rate whose first probability meets a first target condition;

acquiring second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment;

acquiring a first evaluation value based on a network throughput at the third moment, the second time length variation information, and the target decision bit rate at the first moment, the first evaluation value being an evaluation value of the target decision bit rate at the first moment; and

updating a model parameter of the first model based on the first evaluation value until any iteration process meets a first iteration ending condition, to obtain a bit rate decision model, the bit rate decision model being the first model obtained by the iteration process that meets the first iteration ending condition.

In an aspect, a method for bit rate deciding is provided. The method is performed by an electronic device and includes:

acquiring a plurality of third probabilities corresponding to a plurality of third decision bit rates by inputting a network throughput at a fifth moment, first parameter variation information, and a target decision bit rate at a sixth moment to a bit rate decision model, wherein the sixth moment is a previous bit rate decision moment of the fifth moment, and the first parameter variation information is parameter variation information of a buffer at the fifth moment;

determining a target decision bit rate at the fifth moment, the target decision bit rate at the fifth moment being a third decision bit rate whose third probability meets a third target condition; and

adjusting a bit rate of video data based on the target decision bit rate at the fifth moment, the bit rate decision model being a bit rate decision model trained by using the method for training a bit rate decision model in the above aspect.

In an aspect, an electronic device is provided, including:

a processor; and

a memory configured to store an instruction executable by the processor,

wherein the processor is configured to perform the following steps:

acquiring a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment;

determining a target decision bit rate at the first moment, the target decision bit rate at the first moment being a first decision bit rate whose first probability meets a first target condition;

acquiring second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment;

acquiring a first evaluation value based on a network throughput at the third moment, the second time length variation information, and the target decision bit rate at the first moment, the first evaluation value being an evaluation value of the target decision bit rate at the first moment; and

updating a model parameter of the first model based on the first evaluation value until any iteration process meets a first iteration ending condition, to obtain a bit rate decision model, the bit rate decision model being the first model obtained by the iteration process that meets the first iteration ending condition.

In an aspect, an electronic device is provided, including:

a processor; and

a memory configured to store an instruction executable by the processor,

wherein the processor is configured to perform the following steps:

acquiring a plurality of third probabilities corresponding to a plurality of third decision bit rates by inputting a network throughput at a fifth moment, first parameter variation information, and a target decision bit rate at a sixth moment to a bit rate decision model, wherein the sixth moment is a previous bit rate decision moment of the fifth moment, and the first parameter variation information is parameter variation information of a buffer at the fifth moment;

determining a target decision bit rate at the fifth moment, the target decision bit rate at the fifth moment being a third decision bit rate whose third probability meets a third target condition; and

adjusting a bit rate of video data based on the target decision bit rate at the fifth moment, the bit rate decision model being a bit rate decision model trained by using the electronic device described in the foregoing aspect.

In an aspect, a non-transitory storage medium is provided, wherein instructions in the storage medium, when executed by a processor of an electronic device, cause the electronic device to be capable of performing the following steps:

acquiring a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment;

determining a target decision bit rate at the first moment, the target decision bit rate at the first moment being a first decision bit rate whose first probability meets a first target condition;

acquiring second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment;

acquiring a first evaluation value based on a network throughput at the third moment, the second time length variation information, and the target decision bit rate at the first moment, the first evaluation value being an evaluation value of the target decision bit rate at the first moment; and

updating a model parameter of the first model based on the first evaluation value until any iteration process meets a first iteration ending condition, to obtain a bit rate decision model, the bit rate decision model being the first model obtained by the iteration process that meets the first iteration ending condition.

In an aspect, a non-transitory storage medium is provided, wherein instructions in the storage medium, when executed by a processor of an electronic device, cause the electronic device to be capable of performing the following steps:

acquiring a plurality of third probabilities corresponding to a plurality of third decision bit rates by inputting a network throughput at a fifth moment, first parameter variation information, and a target decision bit rate at a sixth moment to a bit rate decision model, wherein the sixth moment is a previous bit rate decision moment of the fifth moment, and the first parameter variation information is parameter variation information of a buffer at the fifth moment;

determining a target decision bit rate at the fifth moment, the target decision bit rate at the fifth moment being a third decision bit rate whose third probability meets a third target condition; and

adjusting a bit rate of video data based on the target decision bit rate at the fifth moment, the bit rate decision model being a bit rate decision model trained by using the storage medium described in the foregoing aspect.

### BRIEF DESCRIPTION OF THE DRAWINGS

FIG. 1 is a schematic diagram of a video data collection type.

FIG. 2 is a schematic structural diagram of a simulated interactive environment.

FIG. 3 is a flowchart of a method for training a bit rate decision model.

FIG. 4 is a flowchart of a method for bit rate deciding.

FIG. 5 is a flowchart of a method for training a bit rate decision model.

FIG. 6 is a schematic structural diagram of an Actor network.

FIG. 7 is a schematic structural diagram of a Critic network.

FIG. 8 is a block diagram of an apparatus for training a bit rate decision model.

FIG. 9 is a block diagram of a bit rate deciding apparatus.

FIG. 10 is a structural diagram of an electronic device.

FIG. 11 is a structural diagram of an electronic device.

FIG. 12 is a sample graph of bandwidth over time.

### DETAILED DESCRIPTION

To make those of ordinary skill in the art better understand the technical solutions of the present disclosure, the following clearly and completely describes the technical solutions in the embodiments of the present disclosure with reference to the accompanying drawings.

It should be noted that the terms “first”, “second”, and so on in the specification and claims of the present disclosure and in the accompanying drawings are intended to distinguish between similar objects but do not necessarily indicate a specific order or sequence. It should be understood that the data used in such a way may be exchanged under proper conditions to make it possible to implement the described embodiments of present disclosure in sequences except those illustrated or described herein. The implementation manners described in the following exemplary embodiments of the present disclosure do not represent all implementation manners consistent with the present disclosure. On the contrary, they are only embodiments of an apparatus and a method detailed in the appended claims and consistent with some aspects of the present disclosure.

Terms in the present disclosure are illustrated hereinafter:

A bit rate is used for indicating how much information is contained in a video block of a certain time length. The video with a higher bit rate at the same compression ratio has higher definition.

A buffer is used for storing video data that has not been sent yet. The size of the buffer is limited. In the field of live streaming, it is desirable to control the video data stored in the buffer to be as small as possible to ensure real-time live streaming.

A network throughput refers to the amount of data transmitted per unit of time.

In related art, a video bit rate is generally controlled using the following method: a bit rate of video data sent by an electronic device is adjusted to maintain the duration of cached video on a client within a given range. For example, the duration of the cached live video on the client is maintained within a range of 10 s to 20 s. When the duration of the cached live video is less than 10 s, the bit rate of transmission is reduced, to reduce the clarity of the video, such that the same video data packet carries a live video of a longer duration; when the duration of the cached live video is longer than 20 s, the bit rate of transmission is increased, to improve the clarity of the video, such that the same video data packet carries a live video of a longer duration.

In embodiments of the present disclosure, a bit rate decision model is trained to predict a bit rate required at a next moment based on network transmission information of a previous moment. The method for training a bit rate decision model in the embodiments of the present disclosure is described below. The method for training a bit rate decision model includes three processes: data collection, training environment creating, and training.

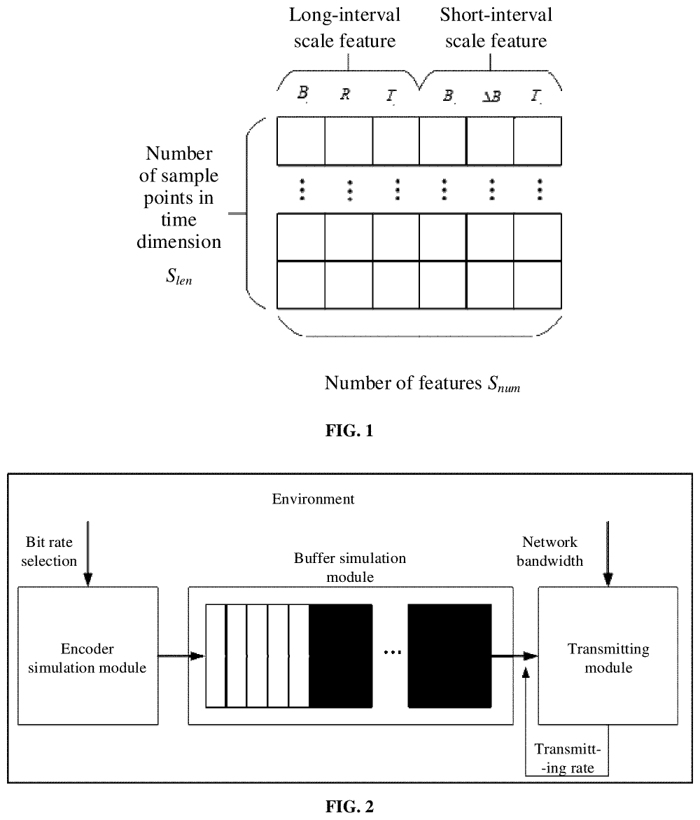

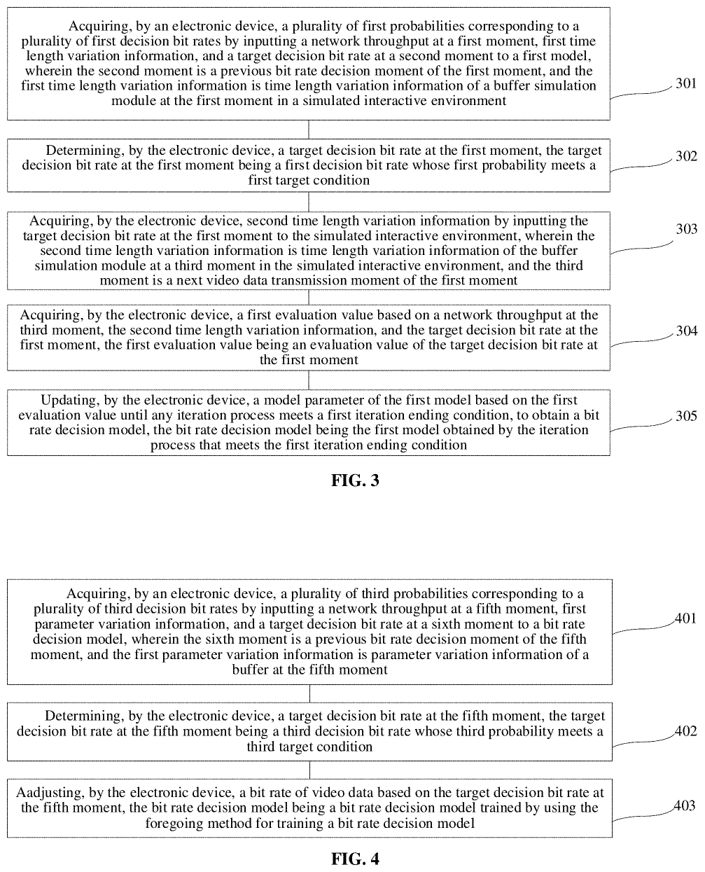

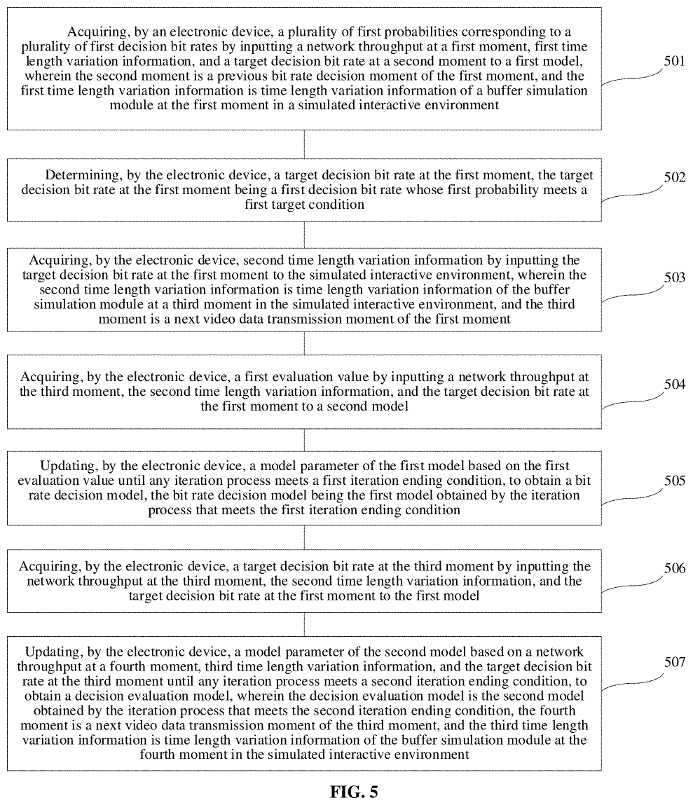

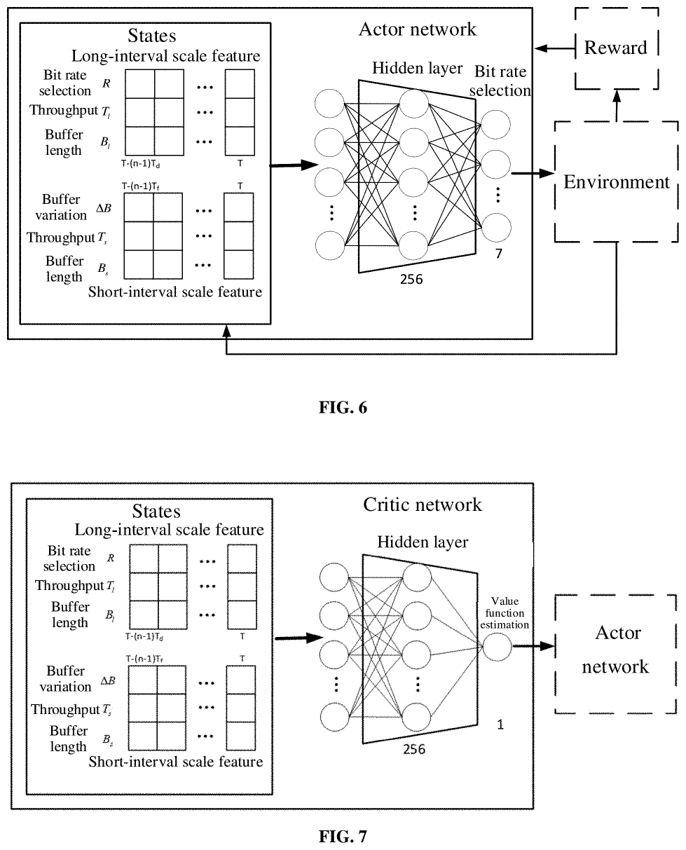

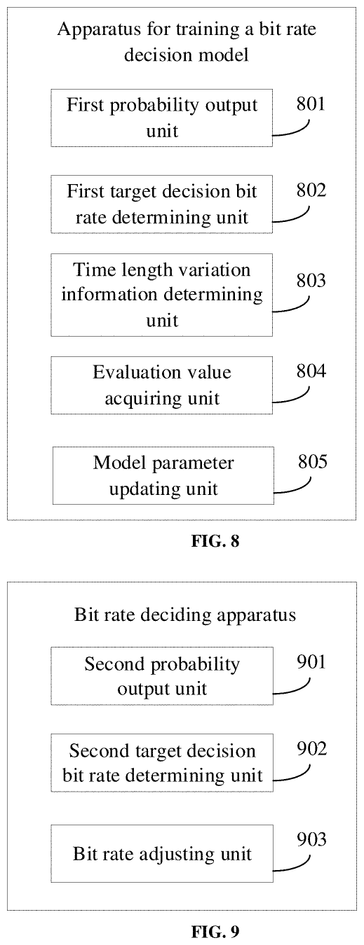

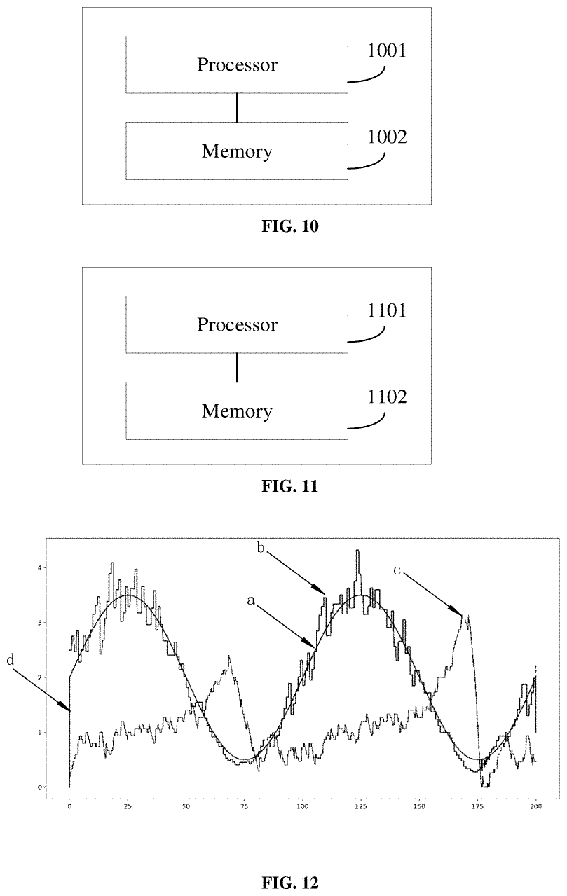

In the data collection process, in some embodiments, an electronic device acquires multiple pieces of related information for indicating a video transmission environment in a data transmission process of the electronic device. The related information includes, but not limited to, a historical network throughput W, buffer time length information B, a historical bit rate decision R, and historical buffer time length variation information ΔB. The related information described above may correspond to different data collection time scales. For example, the data collection time scales may include a long interval and a short interval. The long interval is a time interval between two bit rate decisions, and a short interval is a time interval between two adjacent video frames. Certainly, the duration of the long interval and the duration of the short interval may be set according to actual requirements, which are not limited in the embodiments of the present disclosure. A bit rate decision refers to a manner of adjusting a current bit rate. For example, the form of data collection may be as shown in FIG. 1. The electronic device can collect network throughputs W of the long interval and the short interval simultaneously, which are denoted by WL and Ws respectively, and can also collect buffer time length information B of the long interval and the short interval simultaneously, which are denoted by B_{L} and B_{S} respectively. For the historical bit rate decision R, the electronic device may only collect data in the long interval, which is denoted by R_{L}; and for the historical buffer time length variation information ΔB, the electronic device may only collect data in the short interval, which is denoted by ΔB_{S}. In the foregoing data collection process, the electronic device acquires data of different time scales, which has different meanings for the bit rate decision. Information in the short interval can be used for handling sudden situations in the bit rate decision, while information in the long interval enables the bit rate decision model to capture global information of data, to reduce incorrect decisions.

In the training environment creating process, in some embodiments, a basic model architecture adopts any neural network, for example, deep deterministic policy gradient (DDPG), asynchronous advantage actor-critic (A3C), or policy gradients, which is not limited in the embodiments of the present disclosure.

In some embodiments, if the bit rate decision model is trained in a real environment during actual model training, an actual interaction time is synchronized with the real time. In this case, the bit rate decision model experiences very limited environment changes, resulting in low training efficiency of the bit rate decision model. In embodiments of the present disclosure, the training process of the bit rate decision model can adopt a method of interaction between a simulated interactive environment and the model. Based on this, a simulated interactive environment can be created to simulate actual variations of the network throughput. The electronic device inputs collected records of the real network throughput over time into the simulated interactive environment. The simulated interactive environment sends video data according to the collected real network throughput and acquires related information of a current video transmission environment. The bit rate decision model outputs a corresponding bit rate decision based on the related information of the video transmission environment acquired from the simulated interactive environment. After that, a decision evaluation model outputs an evaluation value according to the decision bit rate outputted by the bit rate decision model. As the bit rate decisions made by the bit rate decision model will affect the simulated interactive environment, the simulated interactive environment will change, and finally the related information fed to the decision evaluation model will also change. The whole training process is the repetition of the above interactions. In some embodiments, the obtained evaluation value is a reward function that helps the bit rate decision model to learn the bit rate decision. In some embodiments, the structure of the simulated interactive environment is shown in FIG. 2, including three modules: an encoder simulation module, a buffer simulation module, and a transmitting simulation module.

The encoder simulation module is configured to receive a bit rate prediction from the bit rate decision model and send video data of the corresponding bit rate to the buffer simulation module. It should be noted that the size of the video data is affected by the size of each frame in the video data in addition to the bit rate. The encoder simulation module can encode the video data to make the size of the video data fluctuate randomly within a certain range that satisfies a bit rate constraint. It is also necessary to set a bit rate and a video data size that match the actual live video on the encoder simulation module.

The buffer simulation module is configured to receive and send video data. The buffer simulation module may be implemented based on a limited-capacity queue. The buffer simulation module receives the video data from the encoder simulation module at certain frame intervals and sends the video data to the transmitting simulation module.

The transmitting simulation module is configured to receive a virtual network throughput, wherein the virtual network throughput is used for simulating the variation of an actual available bandwidth of the network. In some embodiments, the virtual network throughput is a pre-collected record of the real bandwidth over time. The transmitting simulation module is also configured to send the video data from the buffer simulation module based on the limit of the network throughput, thereby achieving the purpose of consuming the video data in the buffer simulation module at a rate determined by the network throughput.

In some embodiments, the encoder simulation module sends video data of a fixed time length to the buffer simulation module at a time. The decision bit rate outputted by the bit rate decision model results in a change in the size of a single piece of video data. For example, if the duration of a piece of video data is 10 s, the current video data size is 50 kilobytes (KB), and the decision bit rate outputted by the bit rate decision model at the next moment is 0.7, the electronic device changes the current bit rate of the video data to be 0.7 times the bit rate at the previous moment, and accordingly, the size of a piece of video data becomes 50×0.7=35 KB.

In some embodiments, the network throughput fluctuates over time. Extracting video data from the buffer simulation module based on the network throughput means that the transmitting simulation module does not extract video data from the buffer simulation module randomly, and the speed of video data extraction depends on the current network throughput. For example, if the current network throughput is 1000 KB/s, it means that the transmitting simulation module can extract 1000 KB of video data per second from the buffer simulation module. If the size of a single piece of video data is 50 KB, the transmitting simulation module can extract 20 pieces of video data per second; if the size of a piece of video data is 25 KB, the transmitting simulation module can extract 40 pieces of video data per second. The remaining capacity of the buffer simulation module changes from time to time. If the current network throughput is small, the transmitting simulation module extracts video data from the buffer simulation module at a lower speed. In this case, since the amount of video data send by the encoder simulation module to the buffer is fixed, the amount of data stored in the buffer simulation module increases, and accordingly, the remaining capacity of the buffer decreases.

In some embodiments, if the video data in the buffer simulation module reaches the capacity limit of the buffer simulation module, the video data is discarded based on the “first-in, first-out” principle.

In the training process, the embodiments of the present disclosure provide a model training process based on a simulated interactive environment. The basic conception is as follows: the electronic device makes a bit rate decision by inputting sample data to a first model, and the first model outputs a decision bit rate; the electronic device inputs the decision bit rate to the simulated interactive environment, and the simulated interactive environment adjusts a transmitting bit rate of video data based on the received decision bit rate. The electronic device acquires time length variation information of the buffer simulation module in the simulated interactive environment in the foregoing process, and inputs the time length variation information of the buffer simulation module, the decision bit rate, and the network throughput to a second model, such that the second model outputs an evaluation value. The electronic device updates a model parameter of the first model based on the evaluation value. The first model, the simulated interactive environment, and the second model interact continuously, to finally obtain the bit rate decision model. The bit rate decision model is capable of predicting a decision bit rate based on related information of the video transmission environment. For the training process of the bit rate decision model, refer to steps 501 to 507.

FIG. 3 is a flowchart of a method for training a bit rate decision model. The method is performed by an electronic device, and as shown in FIG. 3, includes the following steps:

In 301, the electronic device acquires a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment.

In 302, the electronic device determines a target decision bit rate at the first moment, the target decision bit rate at the first moment being a first decision bit rate whose first probability meets a first target condition.

In 303, the electronic device acquires second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment.

In 304, the electronic device acquires a first evaluation value based on a network throughput at the third moment, the second time length variation information, and the target decision bit rate at the first moment, the first evaluation value being an evaluation value of the target decision bit rate at the first moment.

In 305, the electronic device updates a model parameter of the first model based on the first evaluation value until any iteration process meets a first iteration ending condition, to obtain a bit rate decision model, the bit rate decision model being the first model obtained by the iteration process that meets the first iteration ending condition.

In some embodiments, the simulated interactive environment further includes an encoder simulation module and a transmitting simulation module, and the step of acquiring second time length variation information by inputting the target decision bit rate at the first moment to the simulated interactive environment includes:

inputting the target decision bit rate at the first moment to the encoder simulation module, to cause the encoder simulation module to transmit video data of the target decision bit rate at the first moment to the buffer simulation module;

extracting the video data from the buffer simulation module based on a rate indicated by the transmitting simulation module; and

acquiring the second time length variation information based on a storage capacity difference of the buffer simulation module for the video data between the first moment and the third moment.

In some embodiments, the network throughput includes a first network throughput and a second network throughput, the first network throughput is a network throughput within an interval between two video frames, and the second network throughput is a network throughput within a bit rate decision interval.

The time length variation information of the buffer simulation module includes first buffer time length variation information and second buffer time length variation information, the first buffer time length variation information is buffer time length variation information within the interval between two video frames, and the second buffer time length variation information is buffer time length variation information within the bit rate decision interval.

In some embodiments, the step of acquiring a first evaluation value of the target decision bit rate at the first moment based on a network throughput at the third moment, the second time length variation information, and the target decision bit rate at the first moment includes:

acquiring the first evaluation value by inputting the network throughput at the third moment, the second time length variation information, and the target decision bit rate at the first moment to a second model.

In some embodiments, after the step of updating a model parameter of the first model based on the first evaluation value, the method further includes:

acquiring a target decision bit rate at the third moment by inputting the network throughput at the third moment, the second time length variation information, and the target decision bit rate at the first moment to the first model; and

updating a model parameter of the second model based on a network throughput at a fourth moment, third time length variation information, and the target decision bit rate at the third moment until any iteration process meets a second iteration ending condition, to obtain a decision evaluation model, wherein the decision evaluation model is the second model obtained by the iteration process that meets the second iteration ending condition, the fourth moment is a next video data transmission moment of the third moment, and the third time length variation information is time length variation information of the buffer simulation module at the fourth moment in the simulated interactive environment.

In some embodiments, before the step of acquiring a plurality of first probabilities corresponding to a plurality of first decision bit rates by inputting a network throughput at a first moment, first time length variation information, and a target decision bit rate at a second moment to a first model, the method further includes:

acquiring a plurality of second probabilities corresponding to a plurality of second decision bit rates by inputting sample data to the first model in a first model training process, the sample data including a historical decision bit rate, historical buffer time length information, historical buffer time length variation information, and a historical network throughput;

determining a sample target bit rate, the sample target bit rate being a second decision bit rate whose second probability meets a second target condition;

acquiring sample time length variation information of the buffer simulation module in the simulated interactive environment by inputting the sample target bit rate to the simulated interactive environment;

acquiring a second evaluation value by inputting the sample target bit rate, the sample time length variation information, and a network bandwidth at a next video data transmission moment to a second model; and

updating the model parameter of the first model based on the second evaluation value.

FIG. 4 is a flowchart of a method for bit rate deciding. The method is performed by an electronic device, and as shown in FIG. 4, includes the following steps:

In 401, the electronic device acquires a plurality of third probabilities corresponding to a plurality of third decision bit rates by inputting a network throughput at a fifth moment, first parameter variation information, and a target decision bit rate at a sixth moment to a bit rate decision model, wherein the sixth moment is a previous bit rate decision moment of the fifth moment, and the first parameter variation information is parameter variation information of a buffer at the fifth moment.

In 402, the electronic device determines a target decision bit rate at the fifth moment, the target decision bit rate at the fifth moment being a third decision bit rate whose third probability meets a third target condition.

In some embodiments, the third probability meeting the third target condition means that the third probability is the highest among the plurality of third probabilities.

In 403, the electronic device adjusts a bit rate of video data based on the target decision bit rate at the fifth moment, the bit rate decision model being a bit rate decision model trained by using the foregoing method for training a bit rate decision model.

In some embodiments, after the step of adjusting a bit rate of video data based on the target decision bit rate at the fifth moment, the method further includes:

updating a model parameter of the bit rate decision model based on the target decision bit rate at the fifth moment and a network throughput at a seventh moment, the seventh moment being a next video data transmission moment of the fifth moment.

FIG. 5 is a flowchart of a method for training a bit rate decision model. As shown in FIG. 5, the method is performed by an electronic device, and includes the following steps:

In 501, the electronic device acquires a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment.

In some embodiments, the electronic device forms a first parameter matrix by using the network throughput at the first moment, the first time length variation information, and the target decision bit rate at the second moment, and inputs the first parameter matrix to the first model. The parameter matrix is multiplied, by the electronic device, by at least one weight matrix of the first model, to obtain a plurality of first feature vectors, and the plurality of first feature vectors are mapped to a plurality of first probabilities. For example, if the network throughput W at the first moment is 500 Kbps, the target decision bit rate R at the second moment is 0.7, and the first time length variation information ΔB is 3%, the electronic device generates a one-dimensional first parameter matrix [500, 0.7, 3]^{T}. The electronic device multiplies the weight matrix [0.2, 1, 0.3] with the first parameter matrix, to obtain first feature vectors [10, 0.7, 0.9]^{T}, and maps the first feature vectors to a plurality of first probabilities, e.g., [0.76, 0.05, 0.07]^{T}, through a normalization function (SoftMax), wherein numbers in the first feature vectors represent probabilities of the corresponding first decision bit rates.

In some embodiments, an interval between the first moment and the second moment is set in advance, and switching is performed directly at a regular time. In some embodiments, the interval between the first moment and the second moment is determined by the electronic device in real time, which is not limited in the embodiments of the present disclosure. In some embodiments, the first decision bit rate is a multiple of bit rate adjustment or a bit rate value. If the first decision bit rate is a multiple of bit rate adjustment, the first probabilities outputted by the bit rate decision model correspond to different bit rate adjustment multiples, such as 0.7, 0.8, 0.9, 1.0, 1.05, 1.1, and 1.15, wherein each number indicates a multiple for adjusting the bit rate at the previous moment to be the bit rate of the current video data. If 0.7 among the plurality of first decision bit rates corresponds to the highest first probability, the electronic device adjusts the bit rate of the current video data to be 0.7 times the bit rate at the previous moment through the encoder simulation module.

In 502, the electronic device determines a target decision bit rate at the first moment, the target decision bit rate at the first moment being a first decision bit rate whose first probability meets a first target condition.

In some embodiments, the first probability meeting the first target condition means that the first probability is the highest among the plurality of third probabilities.

In 503, the electronic device acquires second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment.

In some embodiments, the simulated interactive environment further includes an encoder simulation module and a transmitting simulation module. The electronic device inputs the target decision bit rate at the first moment to the encoder simulation module, to cause the encoder simulation module to transmit video data at the first moment to the buffer simulation module, and the bit rate of the video data is the target decision bit rate. The electronic device extracts the video data from the buffer simulation module based on a rate indicated by the transmitting simulation module. The electronic device acquires the second time length variation information based on a storage capacity difference of the buffer simulation module for the video data between the first moment and the third moment.

In 504, the electronic device acquires the first evaluation value by inputting the network throughput at the third moment, the second time length variation information, and the target decision bit rate at the first moment to a second model.

In some embodiments, the electronic device forms a second parameter matrix by using the network throughput at the third moment, the second time length variation information, and the target decision bit rate at the first moment. The electronic device inputs the second parameter matrix to the second model, operation is performed on the second parameter matrix by using at least one weight matrix of the second model, to obtain a plurality of second feature vectors. That is, The electronic device obtains a plurality of second feature vectors by multiplying at least one weight matrix of the second model with the second parameter matrix. And, the plurality of second feature vectors are mapped, by the electronic device, to a first evaluation value.

For example, if the network throughput W at the third moment is 450 Kbps, the target decision bit rate R at the first moment is 0.5, and the time length variation information ΔB of the buffer simulation module at the third moment is 2%, the electronic device generates a one-dimensional second parameter matrix [450, 0.5, 2]^{T}. The electronic device multiplies the weight matrix [0.1, 1, 0.5] with the second parameter matrix, to obtain second feature vectors [4.5, 0.5, 1]^{T}, and maps the second feature vectors to a first evaluation value, such as 0.6, through a sigmoid growth curve (Sigmoid).

In 505, the electronic device updates a model parameter of the first model based on the first evaluation value until any iteration process meets a first iteration ending condition, to obtain a bit rate decision model, the bit rate decision model being the first model obtained by the iteration process that meets the first iteration ending condition.

In some embodiments, the electronic device updates the at least one weight matrix of the first model based on the first evaluation value, until a function value of a loss function of the first model is lower than a target threshold or the number of iterations reaches a target count, and at this point, the training of the first model is finished, and the bit rate decision model is obtained, wherein the target threshold and the target count may be set according to actual situations, which are not limited in the embodiments of the present disclosure.

In 506, the electronic device acquires a target decision bit rate at the third moment by inputting the network throughput at the third moment, the second time length variation information, and the target decision bit rate at the first moment to the first model.

The method for determining the target decision bit rate at the third moment by the electronic device belongs to the same inventive conception as the method for determining the target decision bit rate at the first moment, and is not described in detail herein.

In 507, the electronic device updates a model parameter of the second model based on a network throughput at a fourth moment, third time length variation information, and the target decision bit rate at the third moment until any iteration process meets a second iteration ending condition, to obtain a decision evaluation model, wherein the decision evaluation model is the second model obtained by the iteration process that meets the second iteration ending condition, the fourth moment is a next video data transmission moment of the third moment, and the third time length variation information is time length variation information of the buffer simulation module at the fourth moment in the simulated interactive environment.

It should be noted that, before 501 to 507, that is, in the training process of the first model, parameter information of each part in the simulated interactive environment has not been generated yet. Therefore, in some embodiments, the electronic device inputs sample data to the first model, to cause the first model to output a plurality of second probabilities corresponding to a plurality of second decision bit rates, the sample data including a historical decision bit rate, historical buffer time length information, historical buffer time length variation information, and a historical network throughput. The electronic device determines a sample target bit rate, the sample target bit rate being a second decision bit rate whose second probability meets a second target condition. The electronic device acquires sample time length variation information by inputting the sample target bit rate to the simulated interactive environment, and the sample time length variation information is the time length variation information of the buffer simulation module in the simulated interactive environment. The electronic device inputs the sample target bit rate, the sample time length variation information, and a network bandwidth at a next video data transmission moment to the second model, to cause the second model to output a second evaluation value. The electronic device updates the model parameter of the first model based on the second evaluation value. In some embodiments, the second probability meeting the second target condition means that the second probability is the highest among the plurality of second probabilities.

In some embodiments, the sample data is from a user terminal watching the video or from a server. The source of the sample data is not limited in the embodiments of the present disclosure.

In some embodiments, the electronic device can train a plurality of bit rate decision models based on different network bandwidths, and obtain parameters of a primary bit rate decision model based on model parameters of the plurality of bit rate decision models obtained through training. The primary bit rate decision model is the bit rate decision model that makes the bit rate decision in the live streaming process. For example, each of the bit rate decision models can acquire a first reference number of training parameters. The training parameters at least include representing a video transmission environment an evaluation value corresponding to the related information representing the video transmission environment. The electronic device sends the first reference number of training parameters to the primary bit rate decision model through each of the bit rate decision models, and updates the model parameters of the primary bit rate decision model based on the first reference number of training parameters. Then, the electronic device sends the updated model parameters to each of the bit rate decision models through the primary bit rate decision model. The electronic device controls each of the bit rate decision models to replace the model parameters with the received model parameters, and then continues the training in different simulated interactive environments. The foregoing steps are repeated until the electronic device updates the model parameters of the primary bit rate decision model for a reference number of times, and then the training is finished. The reference number of times may be set according to actual requirements, and is not limited in the embodiments of the present disclosure. It should be noted that, the training of the primary bit rate decision model provided in the embodiments of the present disclosure can be finished after the model parameters are updated for the reference number of times as described above; alternatively, time for stopping the training can also be determined based on the loss function of the model, which is not limited in the embodiments of the present disclosure.

The method for training a bit rate decision model provided by the embodiments of the present disclosure is illustrated by using an asynchronous update reinforcement model (actor-critic). The bit rate decision model is an Actor network, and the decision evaluation model is a Critic network. The Critic network is for outputting evaluation values based on time length variation information of the buffer simulation module in the simulated interactive environment obtained by selecting different bit rates at different network throughputs. The Actor network adjusts the model parameters based on the evaluation values outputted by the Critic network. The Critic network adjusts the model parameters based on the related information representing the video transmission environment at the current moment and the decision bit rate at the previous moment. In other words, the Critic network evaluates the decision bit rate outputted by the Actor network, and the Actor network uses the evaluation value outputted by the Critic network as a training target.

In some embodiments, the Actor network adjusts the model parameters through the following formula (1), and the Critic network adjusts the model parameters through the following formula (2):

θₐ←θₐ_{₀}+αₐΣₜ∇_{θ} log π_{θ}(sₜ,aₜ)A(sₜ,aₜ) (1)

θ_{c}←θ_{c}_{₀}−α_{c}Σₜ∇_{θν}(rₜ+γV^{πθ}(sₜ₊₁;θ_{c})−V^{πθ}(sₜ;θᵥ))² (2)

wherein θₐ is a parameter of the Actor network, αₐ is a learning rate of the Actor network, πθ (sₜ, aₜ) is a bit rate prediction of the Actor network, and A (sₜ, aₜ) is an evaluation value outputted by the Critic network; θ_{c} is a parameter of the Critic network, α_{c} is a learning rate of the Critic network, V^{πθ}(sₜ, θ_{c}) is an evaluation value outputted by the Critic network based on network transmission information sₜ at the moment t and the current parameter θ_{c} of the Critic network.

In some embodiments, during the bit rate decision, only the Actor network is in the active state, while during training, both the Actor network and the Critic network are in the active state.

In some embodiments, the last output layer of the Critic network is different from that of the Actor network. The last layer of the Critic network is a linear output layer without an activation function; the last output layer of the Actor network is a SoftMax output layer. Except for the last output layer, all other structures of the Critic network and the Actor network are the same. In some embodiments, the structure of the Actor network is shown in FIG. 6, and the structure of the Critic network is as shown in FIG. 7. It should be noted that, the structures of the Critic network and the Actor network may be designed based on the actual situation, and are not limited in the embodiments of the present disclosure.

FIG. 8 is a block diagram of an apparatus for training a bit rate decision model. Referring to FIG. 8, the apparatus includes a first probability outputting unit 801, a first target decision bit rate determining unit 802, a time length variation information determining unit 803, an evaluation value acquiring unit 804, and a model parameter updating unit 805.

The first probability outputting unit 801 is configured to acquire a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment.

The first target decision bit rate determining unit 802 is configured to determine a target decision bit rate at the first moment, the target decision bit rate at the first moment being a first decision bit rate whose first probability meets a first target condition.

The time length variation information acquiring unit 803 is configured to acquire second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment.

The evaluation value acquiring unit 804 is configured to acquire a first evaluation value based on a network throughput at the third moment, the second time length variation information, and the target decision bit rate at the first moment, the first evaluation value being an evaluation value of the target decision bit rate at the first moment.

The model parameter updating unit 805 is configured to update a model parameter of the first model based on the first evaluation value until any iteration process meets a first iteration ending condition, to obtain a bit rate decision model, the bit rate decision model being the first model obtained by the iteration process that meets the first iteration ending condition.

In some embodiments, the simulated interactive environment further includes an encoder simulation module and a transmitting simulation module, and the time length variation information acquiring unit includes:

a video data transmitting subunit, configured to input the target decision bit rate at the first moment to the encoder simulation module, to cause the encoder simulation module to transmit video data at the first moment to the buffer simulation module, wherein the bit rate of the video data is the target decision bit rate;

a video data extracting subunit, configured to extract the video data from the buffer simulation module based on a rate indicated by the transmitting simulation module; and

a time length variation information acquiring subunit, configured to acquire the second time length variation information based on a storage capacity difference of the buffer simulation module for the video data between the first moment and the third moment.

In some embodiments, the network throughput includes a first network throughput and a second network throughput, the first network throughput is a network throughput within an interval between two video frames, and the second network throughput is a network throughput within a bit rate decision interval.

The time length variation information of the buffer simulation module includes first buffer time length variation information and second buffer time length variation information, the first buffer time length variation information is buffer time length variation information within the interval between two video frames, and the second buffer time length variation information is buffer time length variation information within the bit rate decision interval.

In some embodiments, the evaluation value acquiring unit is configured to acquire the first evaluation value by inputting the network throughput at the third moment, the second time length variation information, and the target decision bit rate at the first moment to a second model.

In some embodiments, the apparatus further includes:

a third moment target bit rate decision determining unit, configured to acquire a target decision bit rate at the third moment by inputting the network throughput at the third moment, the second time length variation information, and the target decision bit rate at the first moment to the first model; and

a decision evaluation model determining unit, configured to update a model parameter of the second model based on a network throughput at a fourth moment, third time length variation information, and the target decision bit rate at the third moment until any iteration process meets a second iteration ending condition, to obtain a decision evaluation model, wherein the decision evaluation model is the second model obtained by the iteration process that meets the second iteration ending condition, the fourth moment is a next video data transmission moment of the third moment, and the third time length variation information is time length variation information of the buffer simulation module at the fourth moment in the simulated interactive environment.

In some embodiments, the first probability outputting unit is further configured to input sample data to the first model in a first model training process, to cause the first model to output a plurality of second probabilities corresponding to a plurality of second decision bit rates, the sample data including a historical decision bit rate, historical buffer time length information, historical buffer time length variation information, and a historical network throughput.

The first target decision bit rate determining unit is further configured to determine a sample target bit rate, the sample target bit rate being a second decision bit rate whose second probability meets a second target condition.

The time length variation information acquiring unit is further configured to acquire sample time length variation information by inputting the sample target bit rate to the simulated interactive environment, wherein the sample time length variation information is the time length variation information of the buffer simulation module in the simulated interactive environment.

The evaluation value acquiring unit is further configured to input the sample target bit rate, the sample time length variation information, and a network bandwidth at a next video data transmission moment to a second model, to cause the second model to output a second evaluation value.

The model parameter updating unit is further configured to update the model parameter of the first model based on the second evaluation value.

Manners of operations performed by the modules in the foregoing apparatus have been described in detail in the related method, and details are not described herein again.

FIG. 9 is a block diagram of a bit rate deciding apparatus. Referring to FIG. 9, the apparatus includes a second probability outputting unit 901, a second target decision bit rate determining unit 902, and a bit rate adjusting unit 903.

The second probability outputting unit 901 is configured to acquires a plurality of third probabilities corresponding to a plurality of third decision bit rates by inputting a network throughput at a fifth moment, first parameter variation information, and a target decision bit rate at a sixth moment to a bit rate decision model, and the first parameter variation information is parameter variation information of a buffer at the fifth moment.

The second target decision bit rate determining unit 902 is configured to determine a target decision bit rate at the fifth moment, the target decision bit rate at the fifth moment being a third decision bit rate whose third probability meets a third target condition.

The bit rate adjusting unit 903 is configured to adjust a bit rate of video data based on the target decision bit rate at the fifth moment, the bit rate decision model being a bit rate decision model trained by using the foregoing apparatus for training a bit rate decision model.

In some embodiments, the apparatus further includes:

a bit rate decision model updating unit, configured to update a model parameter of the bit rate decision model based on the target decision bit rate at the fifth moment and a network throughput at a seventh moment, the seventh moment being a next video data transmission moment of the fifth moment.

Manners of operations performed by the modules in the apparatus in the foregoing embodiment have been described in detail in the embodiments of the related method, and details are not described herein again.

Based on the same conception, an embodiment of the present disclosure further provides an electronic device. As shown in FIG. 10, the electronic device includes:

a processor 1001; and

a memory 1002 configured to store an instruction executable by the processor 1001,

wherein the processor 1001 is configured to perform the following steps:

acquiring a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment;

determining a target decision bit rate at the first moment, the target decision bit rate at the first moment being a first decision bit rate whose first probability meets a first target condition;

acquiring second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment;

acquiring a first evaluation value based on a network throughput at the third moment, the second time length variation information, and the target decision bit rate at the first moment, the first evaluation value being an evaluation value of the target decision bit rate at the first moment; and

updating a model parameter of the first model based on the first evaluation value until any iteration process meets a first iteration ending condition, to obtain a bit rate decision model, the bit rate decision model being the first model obtained by the iteration process that meets the first iteration ending condition.

In some embodiments, the simulated interactive environment further includes an encoder simulation module and a transmitting simulation module, and the processor 1001 is configured to perform the following steps:

inputting the target decision bit rate at the first moment to the encoder simulation module, to cause the encoder simulation module to transmit video data at the first moment to the buffer simulation module, wherein a bit rate of the video data is the target decision bit rate;

extracting the video data from the buffer simulation module based on a rate indicated by the transmitting simulation module; and

acquiring the second time length variation information based on a storage capacity difference of the buffer simulation module for the video data between the first moment and the third moment.

In some embodiments, the network throughput includes a first network throughput and a second network throughput, the first network throughput is a network throughput within an interval between two video frames, and the second network throughput is a network throughput within a bit rate decision interval.

The time length variation information of the buffer simulation module includes first buffer time length variation information and second buffer time length variation information, the first buffer time length variation information is buffer time length variation information within the interval between two video frames, and the second buffer time length variation information is buffer time length variation information within the bit rate decision interval.

In some embodiments, the processor 1001 is configured to perform the following steps:

acquiring the first evaluation value by inputting the network throughput at the third moment, the second time length variation information, and the target decision bit rate at the first moment to a second model.

In some embodiments, the processor 1001 is configured to perform the following steps:

acquiring a target decision bit rate at the third moment by inputting the network throughput at the third moment, the second time length variation information, and the target decision bit rate at the first moment to the first model; and

updating a model parameter of the second model based on a network throughput at a fourth moment, third time length variation information, and the target decision bit rate at the third moment until any iteration process meets a second iteration ending condition, to obtain a decision evaluation model, wherein the decision evaluation model is the second model obtained by the iteration process that meets the second iteration ending condition, the fourth moment is a next video data transmission moment of the third moment, and the third time length variation information is time length variation information of the buffer simulation module at the fourth moment in the simulated interactive environment.

In some embodiments, the processor 1001 is configured to perform the following steps:

acquiring a plurality of second probabilities corresponding to a plurality of second decision bit rates by inputting sample data to the first model in a first model training process, the sample data including a historical decision bit rate, historical buffer time length information, historical buffer time length variation information, and a historical network throughput;

determining a sample target bit rate, the sample target bit rate being a second decision bit rate whose second probability meets a second target condition;

acquiring sample time length variation information by inputting the sample target bit rate to the simulated interactive environment, wherein the sample time length variation information is time length variation information of the buffer simulation module in the simulated interactive environment;

acquiring a second evaluation value by inputting the sample target bit rate, the sample time length variation information, and a network bandwidth at a next video data transmission moment to a second model; and

updating the model parameter of the first model based on the second evaluation value.

Based on the same conception, an embodiment of the present disclosure further provides an electronic device. As shown in FIG. 11, the electronic device includes:

a processor 1101; and

a memory 1102 configured to store an instruction executable by the processor 1101,

wherein the processor 1101 is configured to perform the following steps:

acquiring a plurality of third probabilities corresponding to a plurality of third decision bit rates by inputting a network throughput at a fifth moment, first parameter variation information, and a target decision bit rate at a sixth moment to a bit rate decision model, wherein the sixth moment is a previous bit rate decision moment of the fifth moment, and the first parameter variation information is parameter variation information of a buffer at the fifth moment;

determining a target decision bit rate at the fifth moment, the target decision bit rate at the fifth moment being a third decision bit rate whose third probability meets a third target condition;

and

adjusting a bit rate of video data based on the target decision bit rate at the fifth moment, the bit rate decision model being a bit rate decision model trained by using the electronic device according to claim 17.

In some embodiments, the processor 1101 is configured to perform the following steps:

updating a model parameter of the bit rate decision model based on the target decision bit rate at the fifth moment and a network throughput at a seventh moment, the seventh moment being a next video data transmission moment of the fifth moment.

In some embodiments, the processor may be a central processing unit (CPU), or may be another general-purpose processor, a digital signal processor (DSP), an application specific integrated circuit (ASIC), a field-programmable gate array (FPGA) or another programmable logic device, a discrete gate, a transistor logic device, a discrete hardware component, etc. The general purpose processor may be a microprocessor or any conventional processor, or the like. It should be noted that, the processor may be a processor that supports advanced RISC machines (ARM) architecture.

In some embodiments, the memory may include a read-only memory (ROM) and a random access memory (RAM), and provide instructions and data to the processor. The memory may further include a non-volatile RAM. For example, the storage device may also store information about the device type.

The memory may be a volatile memory or a non-volatile memory, or may include both a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), which is used as an external cache. By way of illustration, but not limitation, many forms of RAM are available, for example, a static RAM (SRAM), a dynamic random access memory (DRAM), a synchronous DRAM (SDRAM), a double data random SDRAM (DDR SDRAM), enhanced SDRAM (ESDRAM), synchlink DRAM (SLDRAM), and direct rambus RAM (DRRAM).

The present disclosure provides a non-transitory storage medium. Instructions in the storage medium, when executed by a processor of an electronic device, cause the electronic device to be capable of performing the following steps:

acquiring a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment;

determining a target decision bit rate at the first moment, the target decision bit rate at the first moment being a first decision bit rate whose first probability meets a first target condition;

acquiring second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment;

acquiring a first evaluation value based on a network throughput at the third moment, the second time length variation information, and the target decision bit rate at the first moment, the first evaluation value being an evaluation value of the target decision bit rate at the first moment; and

updating a model parameter of the first model based on the first evaluation value until any iteration process meets a first iteration ending condition, to obtain a bit rate decision model, the bit rate decision model being the first model obtained by the iteration process that meets the first iteration ending condition.

In some embodiments, the simulated interactive environment further includes an encoder simulation module and a transmitting simulation module, and the electronic device is configured to perform the following steps:

inputting the target decision bit rate at the first moment to the encoder simulation module, to cause the encoder simulation module to transmit video data at the first moment to the buffer simulation module, wherein a bit rate of the video data is the target decision bit rate;

extracting the video data from the buffer simulation module based on a rate indicated by the transmitting simulation module; and

acquiring the second time length variation information based on a storage capacity difference of the buffer simulation module for the video data between the first moment and the third moment.

In some embodiments, the network throughput includes a first network throughput and a second network throughput, the first network throughput is a network throughput within an interval between two video frames, and the second network throughput is a network throughput within a bit rate decision interval.

The time length variation information of the buffer simulation module includes first buffer time length variation information and second buffer time length variation information, the first buffer time length variation information is buffer time length variation information within the interval between two video frames, and the second buffer time length variation information is buffer time length variation information within the bit rate decision interval.

In some embodiments, the electronic device is configured to perform the following steps:

acquiring the first evaluation value by inputting the network throughput at the third moment, the second time length variation information, and the target decision bit rate at the first moment to a second model.

In some embodiments, the electronic device is configured to perform the following steps:

acquiring a target decision bit rate at the third moment by inputting the network throughput at the third moment, the second time length variation information, and the target decision bit rate at the first moment to the first model; and

updating a model parameter of the second model based on a network throughput at a fourth moment, third time length variation information, and the target decision bit rate at the third moment until any iteration process meets a second iteration ending condition, to obtain a decision evaluation model, wherein the decision evaluation model is the second model obtained by the iteration process that meets the second iteration ending condition, the fourth moment is a next video data transmission moment of the third moment, and the third time length variation information is time length variation information of the buffer simulation module at the fourth moment in the simulated interactive environment.

In some embodiments, the electronic device is configured to perform the following steps:

acquiring a plurality of second probabilities corresponding to a plurality of second decision bit rates by inputting sample data to the first model in a first model training process, the sample data including a historical decision bit rate, historical buffer time length information, historical buffer time length variation information, and a historical network throughput;

determining a sample target bit rate, the sample target bit rate being a second decision bit rate whose second probability meets a second target condition;

acquiring sample time length variation information by inputting the sample target bit rate to the simulated interactive environment, wherein the sample time length variation information is time length variation information of the buffer simulation module in the simulated interactive environment;

acquiring a second evaluation value by inputting the sample target bit rate, the sample time length variation information, and a network bandwidth at a next video data transmission moment to a second model; and

updating the model parameter of the first model based on the second evaluation value.

The present disclosure provides a non-transitory storage medium. Instructions in the storage medium, when executed by a processor of an electronic device, cause the electronic device to be capable of performing the following steps:

acquiring a plurality of third probabilities corresponding to a plurality of third decision bit rates by inputting a network throughput at a fifth moment, first parameter variation information, and a target decision bit rate at a sixth moment to a bit rate decision model, wherein the sixth moment is a previous bit rate decision moment of the fifth moment, and the first parameter variation information is parameter variation information of a buffer at the fifth moment;

determining a target decision bit rate at the fifth moment, the target decision bit rate at the fifth moment being a third decision bit rate whose third probability meets a third target condition; and

adjusting a bit rate of video data based on the target decision bit rate at the fifth moment, the bit rate decision model being a bit rate decision model trained by using the electronic device according to claim 17.

In some embodiments, the electronic device is configured to perform the following steps:

updating a model parameter of the bit rate decision model based on the target decision bit rate at the fifth moment and a network throughput at a seventh moment, the seventh moment being a next video data transmission moment of the fifth moment.

FIG. 12 is a sample graph of bandwidth over time. Referring to FIG. 12, a waveform with great fluctuations is selected for verification of the sine-wave network bandwidth. The horizontal coordinate in the figure is time in seconds; curve a is the real bandwidth variation in Mbps; curve b is the buffer time length variation in seconds; curve c is the bit rate selected by the model, in Mbps; curve d is the actual throughput for sending video data, in Mbps. It can be seen that the video bit rate control method provided by the present disclosure can make the actual throughput for sending video data follow the real bandwidth well, so that the throughput for sending video data is almost equal to the actual unpredictable network bandwidth, while keeping the amount of data stored in the buffer at a relatively low level, which ensures both the throughput for sending live video and the real-time performance of the live video streaming.

A person skilled in the art can easily think of other implementation solutions of the present disclosure after considering the specification and practicing the disclosure herein. The present disclosure is intended to cover any variations, purposes or applicable changes of the present disclosure. Such variations, purposes or applicable changes follow the general principle of the present disclosure and include common knowledge or conventional technical means in the technical field which is not disclosed in the present disclosure. The specification and embodiments are merely considered as illustrative, and the real scope and spirit of the present disclosure are pointed out by the appended claims.

It should be noted that, the present disclosure is not limited to the precise structures that have been described above and shown in the accompanying drawings, and can be modified and changed in many ways without departing from the scope of the present disclosure. The scope of the present disclosure is defined by the appended claims.

What is claimed is:

1. A method for training a bit rate decision model, performed by an electronic device, comprising:
acquiring a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment;
determining a target decision bit rate at the first moment, the target decision bit rate at the first moment being a first decision bit rate whose first probability meets a first target condition;
acquiring second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment;
acquiring a first evaluation value based on a network throughput at the third moment, the second time length variation information, and the target decision bit rate at the first moment, the first evaluation value being an evaluation value of the target decision bit rate at the first moment; and
updating a model parameter of the first model based on the first evaluation value until any iteration process meets a first iteration ending condition, to obtain a bit rate decision model.

2. The method according to claim 1, wherein the simulated interactive environment further comprises an encoder simulation module and a transmitting simulation module, and said acquiring second time length variation information by inputting the target decision bit rate at the first moment to the simulated interactive environment comprises:
inputting the target decision bit rate at the first moment to the encoder simulation module, to cause the encoder simulation module to transmit video data at the first moment to the buffer simulation module, wherein a bit rate of the video data is the target decision bit rate;
extracting the video data from the buffer simulation module based on a rate indicated by the transmitting simulation module; and
acquiring the second time length variation information based on a storage capacity difference of the buffer simulation module for the video data between the first moment and the third moment.

3. The method according to claim 1, wherein the network throughput comprises a first network throughput and a second network throughput, the first network throughput is a network throughput within an interval between two video frames, and the second network throughput is a network throughput within a bit rate decision interval; and
the time length variation information of the buffer simulation module comprises first buffer time length variation information and second buffer time length variation information, the first buffer time length variation information is buffer time length variation information within the interval between two video frames, and the second buffer time length variation information is buffer time length variation information within the bit rate decision interval.

4. The method according to claim 1, wherein said acquiring a first evaluation value based on a network throughput at the third moment, the second time length variation information, and the target decision bit rate at the first moment comprises:
acquiring the first evaluation value by inputting the network throughput at the third moment, the second time length variation information, and the target decision bit rate at the first moment to a second model.

5. The method according to claim 4, further comprising:
acquiring a target decision bit rate at the third moment by inputting the network throughput at the third moment, the second time length variation information, and the target decision bit rate at the first moment to the first model; and
updating a model parameter of the second model based on a network throughput at a fourth moment, third time length variation information, and the target decision bit rate at the third moment until any iteration process meets a second iteration ending condition, to obtain a decision evaluation model, wherein the fourth moment is a next video data transmission moment of the third moment, and the third time length variation information is time length variation information of the buffer simulation module at the fourth moment in the simulated interactive environment.

6. The method according to claim 1, further comprising:
acquiring a plurality of second probabilities corresponding to a plurality of second decision bit rates by inputting sample data to the first model in a first model training process, the sample data comprising a historical decision bit rate, historical buffer time length information, historical buffer time length variation information, and a historical network throughput;
determining a sample target bit rate, the sample target bit rate being a second decision bit rate whose second probability meets a second target condition;
acquiring sample time length variation information by inputting the sample target bit rate to the simulated interactive environment, wherein the sample time length variation information is time length variation information of the buffer simulation module in the simulated interactive environment;
acquiring a second evaluation value by inputting the sample target bit rate, the sample time length variation information, and a network bandwidth at a next video data transmission moment to a second model; and
updating the model parameter of the first model based on the second evaluation value.

7. A method for bit rate deciding, performed by an electronic device, comprising:
acquiring a plurality of third probabilities corresponding to a plurality of third decision bit rates by inputting a network throughput at a fifth moment, first parameter variation information, and a target decision bit rate at a sixth moment to a bit rate decision model, wherein the sixth moment is a previous bit rate decision moment of the fifth moment, and the first parameter variation information is parameter variation information of a buffer at the fifth moment;
determining a target decision bit rate at the fifth moment, the target decision bit rate at the fifth moment being a third decision bit rate whose third probability meets a third target condition; and
adjusting a bit rate of video data based on the target decision bit rate at the fifth moment, the bit rate decision model being a bit rate decision model trained by using the method according to claim 1.

8. The method according to claim 7, further comprising:
updating a model parameter of the bit rate decision model based on the target decision bit rate at the fifth moment and a network throughput at a seventh moment, the seventh moment being a next video data transmission moment of the fifth moment.

9. An electronic device, comprising:
a processor; and
a memory configured to store an instruction executable by the processor;
wherein the processor is configured to perform a method comprising:
acquiring a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment;
determining a target decision bit rate at the first moment, the target decision bit rate at the first moment being a first decision bit rate whose first probability meets a first target condition;
acquiring second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment;
acquiring a first evaluation value based on a network throughput at the third moment, the second time length variation information, and the target decision bit rate at the first moment, the first evaluation value being an evaluation value of the target decision bit rate at the first moment; and
updating a model parameter of the first model based on the first evaluation value until any iteration process meets a first iteration ending condition, to obtain a bit rate decision model.

10. The electronic device according to claim 9, wherein the simulated interactive environment further comprises an encoder simulation module and a transmitting simulation module, and the method comprises:
inputting the target decision bit rate at the first moment to the encoder simulation module, to cause the encoder simulation module to transmit video data at the first moment to the buffer simulation module, wherein a bit rate of the video data is the target decision bit rate;
extracting the video data from the buffer simulation module based on a rate indicated by the transmitting simulation module; and
acquiring the second time length variation information based on a storage capacity difference of the buffer simulation module for the video data between the first moment and the third moment.

11. The electronic device according to claim 9, wherein the network throughput comprises a first network throughput and a second network throughput, the first network throughput is a network throughput within an interval between two video frames, and the second network throughput is a network throughput within a bit rate decision interval; and
the time length variation information of the buffer simulation module comprises first buffer time length variation information and second buffer time length variation information, the first buffer time length variation information is buffer time length variation information within the interval between two video frames, and the second buffer time length variation information is buffer time length variation information within the bit rate decision interval.

12. The electronic device according to claim 9, wherein the method comprises:
acquiring the first evaluation value by inputting the network throughput at the third moment, the second time length variation information, and the target decision bit rate at the first moment to a second model.

13. The electronic device according to claim 12, wherein the method comprises:
acquiring a target decision bit rate at the third moment by inputting the network throughput at the third moment, the second time length variation information, and the target decision bit rate at the first moment to the first model; and
updating a model parameter of the second model based on a network throughput at a fourth moment, third time length variation information, and the target decision bit rate at the third moment until any iteration process meets a second iteration ending condition, to obtain a decision evaluation model, wherein the fourth moment is a next video data transmission moment of the third moment, and the third time length variation information is time length variation information of the buffer simulation module at the fourth moment in the simulated interactive environment.

14. The electronic device according to claim 9, wherein the method comprises:
acquiring a plurality of second probabilities corresponding to a plurality of second decision bit rates by inputting sample data to the first model in a first model training process, historical buffer time length information, historical buffer time length variation information, and a historical network throughput;
determining a sample target bit rate, the sample target bit rate being a second decision bit rate whose second probability meets a second target condition;
acquiring sample time length variation information by inputting the sample target bit rate to the simulated interactive environment, wherein the sample time length variation information is time length variation information of the buffer simulation module in the simulated interactive environment;
acquiring a second evaluation value by inputting the sample target bit rate, the sample time length variation information, and a network bandwidth at a next video data transmission moment to a second model; and
updating the model parameter of the first model based on the second evaluation value.

15. An electronic device configured to utilize the bit rate decision model of claim 9, the electronic device comprising:
a processor; and
a memory configured to store an instruction executable by the processor;
wherein the processor is configured to perform a method comprising:
acquiring a plurality of third probabilities corresponding to a plurality of third decision bit rates by inputting a network throughput at a fifth moment, first parameter variation information, and a target decision bit rate at a sixth moment to the bit rate decision model, wherein the sixth moment is a previous bit rate decision moment of the fifth moment, and the first parameter variation information is parameter variation information of a buffer at the fifth moment;
determining a target decision bit rate at the fifth moment, the target decision bit rate at the fifth moment being a third decision bit rate whose third probability meets a third target condition; and
adjusting a bit rate of video data based on the target decision bit rate at the fifth moment,
wherein the bit rate decision model has been trained by using the electronic device according to claim 9.

16. The electronic device according to claim 15, wherein the method comprises:
updating a model parameter of the bit rate decision model based on the target decision bit rate at the fifth moment and a network throughput at a seventh moment, the seventh moment being a next video data transmission moment of the fifth moment.

17. A non-transitory storage medium, wherein instructions in the storage medium, when executed by a processor of an electronic device, cause the electronic device to perform a method comprising:
acquiring a plurality of first probabilities corresponding to a plurality of first decision bit rates by inputting a network throughput at a first moment, first time length variation information, and a target decision bit rate at a second moment to a first model, wherein the second moment is a previous bit rate decision moment of the first moment, and the first time length variation information is time length variation information of a buffer simulation module at the first moment in a simulated interactive environment;
determining a target decision bit rate at the first moment, the target decision bit rate at the first moment being a first decision bit rate whose first probability meets a first target condition;
acquiring second time length variation information by inputting the target decision bit rate at the first moment to the simulated interactive environment, wherein the second time length variation information is time length variation information of the buffer simulation module at a third moment in the simulated interactive environment, and the third moment is a next video data transmission moment of the first moment;
acquiring a first evaluation value based on a network throughput at the third moment, the second time length variation information, and the target decision bit rate at the first moment, the first evaluation value being an evaluation value of the target decision bit rate at the first moment; and
updating a model parameter of the first model based on the first evaluation value until any iteration process meets a first iteration ending condition, to obtain a bit rate decision model.

18. The non-transitory storage medium according to claim 17, wherein the simulated interactive environment further comprises an encoder simulation module and a transmitting simulation module, and the method comprises:
inputting the target decision bit rate at the first moment to the encoder simulation module, to cause the encoder simulation module to transmit video data at the first moment to the buffer simulation module, wherein a bit rate of the video data is the target decision bit rate;
extracting the video data from the buffer simulation module based on a rate indicated by the transmitting simulation module; and
acquiring the second time length variation information based on a storage capacity difference of the buffer simulation module for the video data between the first moment and the third moment.

19. The non-transitory storage medium according to claim 17, wherein the network throughput comprises a first network throughput and a second network throughput, the first network throughput is a network throughput within an interval between two video frames, and the second network throughput is a network throughput within a bit rate decision interval; and
the time length variation information of the buffer simulation module comprises first buffer time length variation information and second buffer time length variation information, the first buffer time length variation information is buffer time length variation information within the interval between two video frames, and the second buffer time length variation information is buffer time length variation information within the bit rate decision interval.

20. A non-transitory storage medium, wherein instructions in the storage medium, when executed by a processor of an electronic device, cause the electronic device to perform a method that utilizes the bit rate decision model of claim 9, the method comprising:
acquiring a plurality of third probabilities corresponding to a plurality of third decision bit rates by inputting a network throughput at a fifth moment, first parameter variation information, and a target decision bit rate at a sixth moment to the bit rate decision model, wherein the sixth moment is a previous bit rate decision moment of the fifth moment, and the first parameter variation information is parameter variation information of a buffer at the fifth moment;
determining a target decision bit rate at the fifth moment, the target decision bit rate at the fifth moment being a third decision bit rate whose third probability meets a third target condition; and
adjusting a bit rate of video data based on the target decision bit rate at the fifth moment,
wherein the bit rate decision model has been trained by using the electronic device according to claim 9.
